(19) United States
(12) Patent Application Publication
(10) Pub. No.: US 2014/0138296 A1
(43) Pub. Date: May 22, 2014

(54) IODINE ADSORBENT, TANK FOR WATER TREATMENT, AND IODIDE COMPOUND TREATMENT SYSTEM

(71) Applicant: Kabushiki Kaisha Toshiba, Minato-ku (JP)

(72) Inventors: Yumiko SEKIGUCHI, Kanagawa (JP); Tomohito Ide, Tokyo (JP); Arisa Yamada, Kanagawa (JP); Hideyuki Tsuji, Kanagawa (JP)

(73) Assignee: Kabushiki Kaisha Toshiba, Minato-ku (JP)

(21) Appl. No.: 14/084,760

(22) Filed: Nov. 20, 2013

(30) Foreign Application Priority Data
Nov. 20, 2012 (JP) 2012-254728
Nov. 18, 2013 (JP) 2013-238135

(51) Int. Cl. C02F 1/28; B01J 20/22

(52) U.S. Cl. CPC C02F 1/288; B01J 20/22
USPC 210/96.1; 252/181; 210/263

(57) ABSTRACT

An iodine adsorbent of an embodiment includes: an iodine adsorbent including a carrier, an organic group binding to the carrier, and silver. The organic group has a functional group represented by S⁻ or SR at the terminal, the silver binds to the sulfur in S⁻ or SR, the R is a hydrogen atom or a substituent containing hydrocarbon, and the atomic ratio of the silver to the sulfur is 2.6 or more and 2.9 or less.

### CROSS-REFERENCE TO RELATED APPLICATION

This application is based upon and claims the benefit of priority from Japanese Patent Applications No. 2012-254728 Nov. 20, 2012 and Japanese Patent Applications No. 2013-238135 Nov. 18, 2013; the entire contents of which are incorporated herein by reference.

### FIELD

Embodiments described herein relate generally to an iodine adsorbent, a tank for water treatment, and an iodide compound treatment system.

### BACKGROUND

Due to the development of industry and increase in population, effective utilization of water resources has been required. Thus, reuse of waste water is very important. In order to achieve the effective utilization and reuse, it is necessary to purify the water, namely, to separate other substances from the water. As a method of separating other substances from liquid, various methods have been known, and there can be cited, for example, membrane separation, centrifugal separation, active carbon adsorption, ozonation, and aggregation, with which the removal of suspended solids or the like is conducted. Such methods make it possible to remove chemical substances such as iodine and nitrogen contained in water, which greatly affect on the environment, and to remove oils, clays and the like dispersed in water.

Iodine is an element playing an important role in various fields, such as a pharmaceutical field such as X-ray contrast agents and labeling reagents for diagnostic imaging, an optical field such as laser and a polarizer for LCD, and an electronic material field such as organic conductors and dye-sensitized solar cells. Therefore, due to the expansion of demand or recent tightening of environmental regulation, importance of recovery and reuse of iodine is increasing.

As a method of selectively recovering iodine, silver-impregnated activated carbon and silica gel are commercially available. These utilize the binding strength of silver and iodine. However, it is considered that, in these materials, silver is only deposited as a salt on activated carbon or silica gel, due to the production process. Therefore, the supported amount of silver is small, and when used in water, performance degradation due to elution of silver is a concern.

### BRIEF DESCRIPTION OF THE DRAWINGS

FIG. 1 is a conceptual diagram of a water treatment system (iodide compound treatment system) using the iodine adsorbent of the embodiment; and

FIG. 2 is a conceptual diagram of a tank for water treatment of the embodiment connected to pipings.

### DETAILED DESCRIPTION

An iodine adsorbent of an embodiment includes: an iodine adsorbent including a carrier, an organic group binding to the carrier, and silver. The organic group has a functional group represented by S⁻ or SR at the terminal, the silver binds to the sulfur in S⁻ or SR, the R is a hydrogen atom or a substituent containing hydrocarbon, and the atomic ratio of the silver to the sulfur is 2.6 or more and 2.9 or less.

Embodiments will be described below with reference to the drawings.

(Iodine Adsorbent)

The iodine adsorbent of the embodiment has a carrier, an organic group binding to the carrier, that has a functional group represented by S⁻ or SR at the terminal, and silver bound to the sulfur in S⁻ or SR. R is a hydrogen atom or a substituent containing hydrocarbon.

As the carrier of the embodiment, a member that can impart to the iodine adsorbent a strength which is high enough for practical use is preferred. As the carrier into which the organic group is introduced, one having many hydroxyl groups on its surface, and in which percentage of modification of the carrier with the functional group through the manufacturing method to be described below, becomes high is preferred. Here, an acidic carrier or a neutral carrier in which an acidic carrier is previously subjected to neutralization treatment may be used. The neutralization treatment includes, for example, a treatment that the carrier is treated in an additive such as calcium ion. As such carrier, specifically, at least any of silica gels (SiO₂, neutral, acid), metal oxides, acrylic resins and the like can be used.

Here, the metal oxides include aluminosilicate alkoxides and halides forming titania (TiO₂), alumina, (Al₂O₃), and zirconia (ZrO₂), cobalt trioxide (CoO₃), cobalt oxide (CoO), tungsten oxide (WO₃), molybdenum oxide (MoO₃), indium tin oxide (ITO), indium oxide (In₂O₃), lead oxide (PbO₂), PZT, niobium oxide (Nb₂O₅), thorium oxide (ThO₂), tantalum oxide (Ta₂O₅), calcium titanate (CaTiO₃), lanthanum cobaltate (LaCoO₃), rhenium trioxide (ReO₃), chromium oxide (Cr₂O₃), iron oxide (Fe₂O₃), lanthanum chromite (LaCrO₃) or barium titanate (BaTiO₃), and the like.

Note that among the aforementioned carriers, silica gels, titania, alumina and zirconia are preferred since each of them has a high proportion of hydroxyl groups for binding an organic group on the surface, resulting in that the percentage of modification of the organic groups becomes high.

In addition, it is also possible that the above carrier is set to an acrylic resin. The acrylic resin itself also has a sufficient strength, can impart to the iodine adsorbent a strength which is high enough for practical use and has an ester bond position, thus can modify the organic group at a high rate by transesterification. In addition, since an acrylic resin can synthesize a carrier having a glycidyl skeleton, it is possible to synthesize a carrier, for example, using glycidyl methacrylate or the like as a monomer, and modify the organic group at a high rate.

Regarding a size of the carrier in the present embodiment, it is preferred that the average primary particle size be 100 μm or more and 5 mm or less. When the carrier has an average primary particle size of 100 μm or more and 5 mm or less, for example, it is possible to realize both of a high filling rate of the iodine adsorbent in a column, cartridge or tank and easiness of water-flow, when performing adsorption of iodine. When the average primary particle size is less than 100 μm, the filling rate of the iodine adsorbent in the column or the like becomes too high to reduce the void ratio, thus it becomes difficult to make water flow. On the other hand, when the average primary particle size exceeds 5 mm, the filling rate of the iodine adsorbent in the column or the like is too low to increase the void, thus it becomes easy to make water flow. However, the contact area between the iodine adsorbent and waste water containing iodine is reduced, thus the percentage of adsorption of iodine achieved by the iodine adsorbent is reduced. The average primary particle size of the carrier is preferably 100 μm or more and 2 mm or less, and further preferably 100 μm or more and 300 μm or less, or 300 μm or more and 1 mm or less.

The average primary particle size can be measured by a sieving method. Specifically, in accordance with JIS Z8901: 2006 “Test powders and test particles”, it is possible to measure the average primary particle size by performing sieving using a plurality of sieves each having an opening between 100 μm and 5 mm.

Here, in the iodine adsorbent of the present embodiment, the size of the adsorbent itself can be adjusted only by changing the size of the carrier, and it can be understood that, for obtaining an adsorbent that is easy to handle, the size of the carrier should be set to a predetermined size. Specifically, it is possible to obtain an iodine adsorbent that is easy to handle can be obtained without performing operation such as granulation. In addition, since it is not necessary to perform granulation or the like, it is possible to simplify a manufacturing process required for obtaining the iodine adsorbent that is easy to handle, resulting in that the reduction in cost can be realized.

The organic group of the embodiment binds to a carrier, and has a functional group represented by S⁻ or SR at the terminal. S⁻ means a thiolate site. SR at the terminal means a functional group such as thiol, sulfide and thioester polyol. When R in SR is a large functional group, coordination of a metal or metal ion or adsorption of iodine is possibly inhibited, due to steric hindrance or the like. Therefore, the carbon number of R that is a substituent is preferably 6 or less. It will be described below supposing that SR is a thiol site. A coupling agent having these functional groups is reacted with a carrier, an organic group is introduced into the carrier. When an organic group is introduced with the coupling agent, the structure between an oxygen bound to the carrier and the terminal sulfur is preferably an alkyl chain or alkoxy chain having a straight chain or side chain having 1 to 6 carbon atoms.

Silver binds to the sulfur of the embodiment and functions as an iodine adsorbent. When silver is an ion, a monovalent silver ion is preferable. When silver is zero valent, example of zero valent silver includes those in which the silver ion is reduced by sulfur in the organic group. The silver ion may have an ionic bonding with an anion to be paired.

The neutral carrier of the embodiment is previously subjected to neutralization treatment, thus it is considered that there is also a site to which silver binds other than sulfur. In addition, the introduction amount of the organic group in the acid carrier of the embodiment is considered to be more than that of the neutral carrier. Therefore, it is considered that there are many functional groups represented by S⁻ or SR in the adsorbent.

In the case of measuring XPS (X-ray Photoelectron Spectroscopy), the atomic ratio of the silver to the sulfur in the organic group of the embodiment is preferably 2.6 or more and 2.9 or less. This numerical range means that there is a site to which the silver can coordinate or bind, other than the sulfur in the organic group of the embodiment. Alternatively, it is also suggested that the silver is clustered. The atomic ratio of the silver to the sulfur in the organic group is determined by XPS. The measurement conditions are as described below.
Apparatus: Quantum-2000 manufactured by Physical Electronics, Inc.
X-ray source/X-ray output/analysis area: single crystal spectrum A1 Kα ray/40 W/φ200 μm
Pass Energy: Wide Scan-187.85 eV (1.60 eV/Step), Narrow Scan-58.7 eV (0.125 eV/Step)
Charge neutralization gun: using both Ar⁺, e⁻
Geometry: θ=45° (θ: Angle between sample surface and detector)
Sensitivity coefficient in half quantity: sensitivity coefficient recommended by the manufacturer

The anion paired to the silver ion is an organic acid ion or inorganic acid ion. The organic acid ion paired to the silver ion includes acetate ion, lactate ion, citrate ion, salicylate ion and the like. Also, the inorganic acid ion paired to the silver ion includes nitrate ion, sulfate ion, carbonate ion, chlorate ion, nitrite ion, perchlorate ion, sulfite ion, and the like. These anions may be contained in the iodine adsorbent.

The organic group of the embodiment has a thiol site or thiolate site at the terminal. A sulfur atom binds to silver, and thus a carrier is modified by the aforementioned organic group, whereby silver can be coordinated to the carrier.

In the iodine adsorbent in the embodiment, the silver contained in the iodine adsorbent is considered to adsorb iodine contained in the treated water. Specifically, in the treated water, iodine is present in the anionic form such as iodide ion (I⁻) or iodate ion (IO₃⁻), and it is considered that such anion binds to silver, thereby adsorbing iodine in the treated water.

(Manufacturing Method of Iodine Adsorbent)

Next, a manufacturing method of the iodine adsorbent of the present embodiment will be described. Note that a manufacturing method to be described below is an example, and is not particularly limited as long as the iodine adsorbent of the present embodiment can be obtained. Here, after being subjected to each treatment, it is preferred that the treated substance be filtered, washed with a proper solvent such as a reaction solvent, toluene, pure water or alcohol, and dried, then subjected to a next treatment.

First, a carrier such as the acid or neutral silica gel or titania described above is prepared, and the surface of the carrier is treated with a coupling agent having a thiol site or a sulfide site to introduce the thiol site or the sulfide site into the carrier. The carrier is selected from them. The coupling agent includes thiol coupling agents such as γ-sulfanylpropyltrimethoxysilane, γ-sulfanylpropyltriethoxysilane and 3-mercaptopropylmethyldimethoxysilane, sulfide coupling agents such as bis(triethoxysilylpropyl)tetrasulfide, coupling agents such as sulfanyl titanate, sulfanyl alumichelate and sulfanyl zircoaluminate.

Regarding a reaction between the coupling agent and the carrier, there are a method in which the coupling agent is vaporized to be reacted with the carrier, a method in which the coupling agent is mixed in a solvent, and the mixture is mixed with the carrier to cause the reaction, and a method in which the coupling agent is directly brought into contact with the carrier without using the solvent to cause the reaction. When the reaction is caused in each of the methods, by performing heating, pressure reduction or the like, the introduction amount (proportion) of the coupling agent can be adjusted.

Regarding the reaction solvent, aromatic solvents are more preferable, and those that can dissolve a coupling agent having a thiol site or a thiolate site, such as alcohols and mixed solvents of alcohols and water, may be used. Specifically, when an aromatic solvent is used, it is preferred in that hydrolysis of coupling agent is unlikely to occur, and condensation reaction among coupling agents is unlikely to occur. However, when using an aromatic solvent, since hydrolysis of coupling agent is unlikely to occur, it is preferable to carry out treatment at a higher temperature. On the other hand, in a water-soluble solvent, since hydrolysis of coupling agent is likely to occur, and condensation reaction among coupling agents is likely to occur, it is preferable to carry out treatment at a temperature lower than room temperature.

The carrier into which the organic group is introduced by coupling reaction may be directly used for supporting reaction of silver, and may be subjected to heat treatment in an alcoholic solvent before supporting silver. As the alcoholic solvent, methanol, ethanol, propanol, butanol and the like can be used. An organic solvent such as acetone, THF, DMSO or DMF can be also used, depending on the carrier and the organic group. Here, the heating temperature is different in the preferred range, depending on the solvent, but is preferably room temperature (25° C.) or more and a boiling point or less. While the principle of this treatment has not yet been clear, the iodine adsorption ability of the iodine adsorbent is improved.

Subsequently, silver is supported on the carrier obtained as described above. For example, there can be cited a method in which an aqueous solution of a salt of inorganic acid or organic acid of silver is prepared, and then the above carrier is immersed in the aqueous solution and stirred, a method in which the above carrier is filled in a column, and the above aqueous solution is made to flow through the column, and the like.

The salt of inorganic acid or organic acid of silver includes silver nitrate, silver sulfate, silver carbonate, silver chlorate, silver nitrite, silver perchlorate, silver sulfite, silver acetate, silver lactate, silver citrate, silver salicylate, and the like, and silver nitrate is preferable, from the viewpoint of solubility in water.

Here, while a method of introducing an organic group having a thiol group into an inorganic substance as a carrier by silane coupling reaction with its oxidized surface or a hydroxyl group is previously described, the structure of the embodiment can be obtained also by a reaction using an organic substance as a support. The organic carrier described above includes acrylic resins. The acrylic resin has high mechanical strength and has an ester bond position, thus an organic group having a thiol site or a sulfide site can be introduced by transesterification.

In addition, it is possible to introduce a glycidyl group into the acrylic resin when using, for example, glycidyl methacrylate as a monomer. A glycidyl group has an epoxy group at the terminal, and this undergoes a ring-opening addition reaction with alcohol or amine. Therefore, the glycidyl group is reacted with a compound having a hydroxyl group or amino group at one terminal and having a thiol group at the other terminal, whereby an organic group having a thiol group at the terminal can be introduced. The aforementioned compound includes 2-aminoethanethiol, 3-aminopropanethiol, 4-aminobutanethiol, 2-sulfanylethanol, 3-sulfanylpropanol, 4-sulfanylbutanol, and the like.

(Method of Using Iodine Adsorption System and Iodine Adsorbent and Iodide Compound Treatment System)

Next, an adsorption system using the aforementioned iodine adsorbent and a method of using the adsorption system will be explained. An iodide compound treatment system including an adsorbent unit having an iodine adsorbent, a supplying unit supplying target medium including iodide compound for the iodine adsorbent of the adsorbent unit, a discharging unit discharging target medium from the adsorbent unit, a measuring unit measuring concentration of iodide compound in the target medium provided in the supplying unit side and/or the discharging unit side, and a controller controlling flow of the target medium from the supplying unit to the adsorbent unit when a value calculated from a measured value in the measuring unit reaches set value.

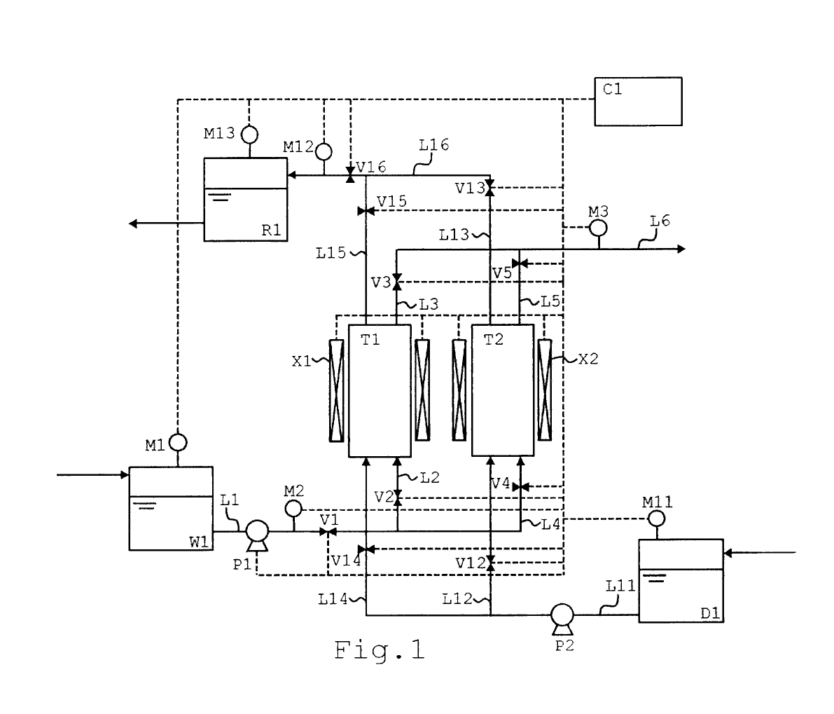

FIG. 1 is a conceptual diagram illustrating a schematic configuration of an apparatus (system) used for adsorption of iodine and treatment system in the present embodiment. As illustrated in FIG. 1, in the present apparatus, tanks (adsorbent unit) for water treatment T1 and T2 filled with the aforementioned iodine adsorbent are disposed in parallel, and on lateral sides of the tanks for water treatment T1 and T2, contact efficiency accelerators X1 and X2 are provided. The contact efficiency accelerators X1 and X2 can be provided as mechanical stirrers or non-contact magnetic stirrers, but, they are not essential components and thus can also be omitted.

In addition, to the tanks for water treatment T1 and T2, a waste water storage tank W1 in which waste water (target medium) containing iodine is stored, is connected via waste water supply lines (supplying unit) L1, L2 and L4, and the tanks are connected to the outside via waste water discharge lines(discharging unit) L3, L5 and L6.

Note that to the supply lines L1, L2, and L4, there are provided valves (controller) V1, V2, and V4, respectively, and to the discharge lines L3 and L5, there are provided valves V3 and V5, respectively. Also, to the supply line L1, a pump P1 is provided. Further, to the waste water storage tank W1, the supply line L1 and the discharge line L6, concentration measuring units (measuring unit) M1, M2 and M3 are respectively provided.

Moreover, the control of the aforementioned valves and pump, monitoring of measured values in the measuring units are collectively and centrally controlled by a controller (controller) C1.

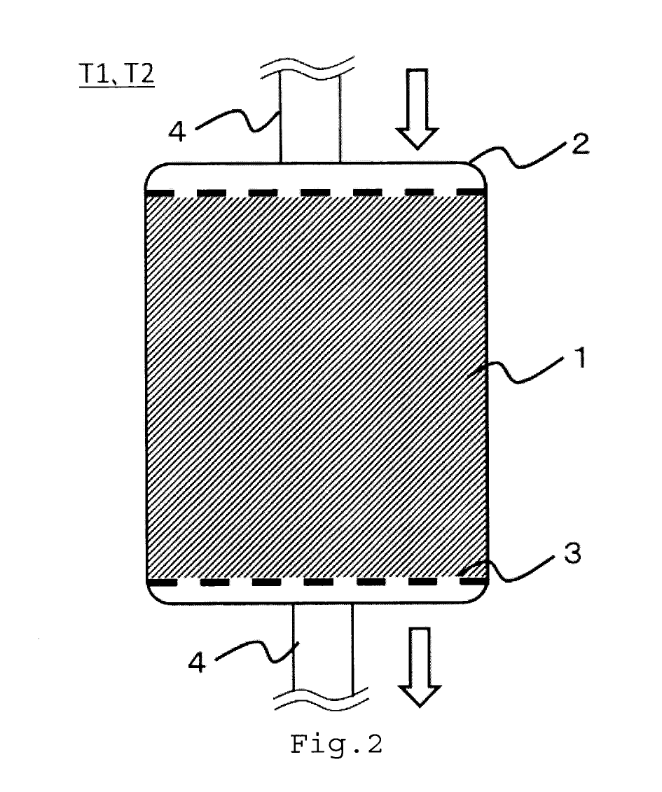

FIG. 2 illustrates a conceptual cross sectional view of tanks for water treatment T1 and T2 filled with the iodine adsorbent connected to pipings 4 (L2 to L4). Arrows in the figure illustrate the flow direction of treated water (target medium). The tanks for water treatment T1 and T2 comprise iodine adsorbent 1, tank 2 to accommodate the iodine adsorbent, and partition board 3 so as not to allow the iodine adsorbent to leak outside the tank 2. The tanks for water treatment T1 and T2 may be a cartridge form in which the tank 2 itself is exchangeable or may be a form in which the iodine adsorbent in the tank 2 is exchangeable. When there is anything to be adsorbed and collected other than iodine, other adsorbent can be accommodated in the tank 2.

Next, the adsorption operation of iodine using the apparatus (system) illustrated in FIG. 1 will be described.

First, waste water is supplied from the tank W1 to the tanks for water treatment T1 and T2 through the waste water supply lines L1, L2 and L4 using the pump P1. At this time, iodine in the waste water is adsorbed in the tanks for water treatment T1 and T2, and the waste water after the adsorption is performed is discharged to the outside through the waste water discharge lines L3 and L5.

At this time, it is possible to enhance the adsorption efficiency of iodine provided by the tanks for water treatment T1 and T2, by driving the contact efficiency accelerators X1 and X2 as necessary, to increase the contact area between the iodine adsorbent filled in the tanks for water treatment T1 and T2 and the waste water.

Here, adsorption states of the tanks for water treatment T1 and T2 are observed by the concentration measuring unit (measuring unit) M2 provided on the supply side and the concentration measuring unit (measuring unit) M3 provided on the discharge side, respectively, of the tanks for water treatment T1 and T2. When the adsorption proceeds smoothly, the concentration of iodine measured by the concentration measuring unit M3 indicates a value lower than that of the concentration of iodine measured by the concentration measuring unit M2. However, as the adsorption of iodine in the tanks for water treatment T1 and T2 gradually proceeds, a difference in the concentrations of iodine in the concentration measuring units M2 and M3 disposed on the supply side and the discharge side is decreased. It is preferable that the measuring concentration of iodide in the target medium is conducted sequentially.

Therefore, when the value measured by the concentration measuring unit M3 reaches a previously set predetermined value, and it is judged that the adsorption ability of iodine of the tanks for water treatment T1 and T2 reaches saturation, the controller C1 once stops the pump P1, closes the valves V2, V3 and V4, and stops the supply of waste water to the tanks for water treatment T1 and T2, based on the information from the concentration measuring units M2 and M3.

Note that, although not illustrated in FIG. 1, when a pH of the waste water fluctuates, or the pH is strongly acidic or strongly alkaline and is out of a pH range suitable for the adsorbing material according to the present embodiment, it is also possible that the pH of the waste water is measured by the concentration measuring unit M1 and/or M2 and is adjusted through the controller C1.

After the adsorption ability of iodine of the tanks for water treatment T1 and T2 reaches saturation, the tanks are appropriately changed with new tanks for water treatment filled with the iodine adsorbent, and the tanks for water treatment T1 and T2 in which the adsorption of iodine reaches saturation are appropriately subjected to necessary post-treatment. For example, when the tanks for water treatment T1 and T2 contain radioiodine, the tanks for water treatment T1 and T2 are broken into pieces, and then subjected to cement solidification and stored as radioactive waste in an underground facility or the like.

Note that although the adsorption system of iodine in the waste water using the tanks for water treatment and the operation of the system, are explained in the above example, it is also possible to adsorb and remove iodine in exhaust gas by making exhaust gas containing iodine pass through the tank or column as described above.

Hereinafter, the disclosure will be specifically described with reference to the examples.

### EXAMPLE 1

A recovery flask (50 ml) equipped with a magnetic stir bar and a Dimroth condenser was charged with 3-mercaptopropyl trimethoxy silane (8.6 g, 43.7 mmol) and toluene (20 ml), and the mixture was stirred to form a homogeneous solution. Thereto was added silica gel (neutral silica gel, silica gel 60 N manufactured by KANTO CHEMICAL CO., INC., 5.16 g), and the mixture was heated and stirred at 110° C. for 10 hours. The temperature of the flask was returned to room temperature, and the silica gel was separated by filtration. The silica gel was washed with toluene (30 ml), then the solvent was distilled off under reduced pressure, to obtain a silica gel into which the organic group was introduced as a colorless particle (yield=6.1 g).

Subsequently, the silica gel carrier (0.970 g) into which the organic group was introduced as described above was placed in a recovery flask (50 ml) equipped with a magnetic stir bar and a Dimroth condenser. Thereto were added mathanol (20 ml) and glucono-δ-lactone (0.959g, 5.38 mmol), and the mixture was heated and stirred at 60° C. for 6 hours. The temperature of the flask was returned to room temperature, and the silica gel was separated by filtration. The silica gel was washed with in order of methanol (20 ml) and pure water (30 ml), then the solvent was distilled off under reduced pressure, to obtain a denatured form of a silica gel carrier having an organic group as a colorless particle (yield=0.902 g).

Subsequently, the denatured form of the silica gel carrier having an organic group (0.500 g) was placed in a screw vial (20 ml), and a 3% by weight aqueous silver nitrate solution (10 ml) was added thereto, then the mixture was stirred at room temperature at 60 rpm using a horizontal mixing rotor under light shielding for 1 hour. The mixture was filtered and well washed with pure water, then again placed in a screw vial (20 ml), and pure water (10 ml) was added thereto, then the mixture was stirred at room temperature at 60 rpm using a horizontal mixing rotor under light shielding for 2 hours. The silica gel was again separated by filtration, and well washed with pure water. The solvent was distilled off under reduced pressure, to obtain an adsorbent of Example 1 as a pale yellow particle (yield=0.586 g).

### EXAMPLE 2

The same procedures were carried out as in Example 1, except for not using glucono-δ-lactone, to obtain the adsorbent of Example 2.

Subsequently, the silica gel carrier (0.135 g) into which the organic group was introduced as described in Example 1 was placed in a recovery flask (50 ml) equipped with a magnetic stir bar and a Dimroth condenser. Thereto was added mathanol (5 ml), and the mixture was heated and stirred at 60° C. for 3 hours. The temperature of the flask was returned to room temperature, and the silica gel was separated by filtration. The silica gel was washed with methanol (10 ml), then the solvent was distilled off under reduced pressure, to obtain a denatured form of a silica gel carrier having an organic group as a colorless particle (yield=0.116 g).

The denatured form of the silica gel carrier having an organic group (0.116 g) was placed in a screw vial (6 ml) as described above, and a 3% by weight aqueous silver nitrate solution (2 ml) was added thereto, then the mixture was stirred at room temperature at 60 rpm using a horizontal mixing rotor under light shielding for 1 hour. The mixture was filtered and well washed with pure water, then again placed in a screw vial (6 ml), and pure water (2 ml) was added thereto, then the mixture was stirred at room temperature at 60 rpm using a horizontal mixing rotor under light shielding for 2 hours. The silica gel was again separated by filtration, and well washed with pure water. The solvent was distilled off under reduced pressure, to obtain an adsorbent of Example 2 as a pale yellow particle (yield=0.144 g).

### EXAMPLE 3

The same procedures were carried out as in Example 1, except for not heating the mixed solution under reflux in methanol, to obtain the adsorbent of Example 3.

The silica gel carrier having an organic group (0.100 g) was placed in a screw vial (6 ml) as described in Example 1, and a 3% by weight aqueous silver nitrate solution (2 ml) was added thereto, then the mixture was stirred at room temperature at 60 rpm using a horizontal mixing rotor under light shielding for 1 hour. The mixture was filtered and well washed with pure water, then again placed in a screw vial (6 ml), and pure water (2 ml) was added thereto, then the mixture was stirred at room temperature at 60 rpm using a horizontal mixing rotor under light shielding for 2 hours. The silica gel was again separated by filtration, and well washed with pure water. The solvent was distilled off under reduced pressure, to obtain an adsorbent of Example 3 as a pale yellow particle.

### COMPARATIVE EXAMPLE 1

The same procedures were carried out as in Example 1, except for using Quadra Sil™ (manufactured by Sigma-Aldrich Co. LLC.) as a carrier, to obtain the adsorbent of Comparative Example 1.

Quadra Sil™ (0.500 g) was placed in a screw vial (20 ml), and a 3% by weight aqueous silver nitrate solution (10 ml) was added thereto, then the mixture was stirred at room temperature at 60 rpm using a horizontal mixing rotor under light shielding for 1 hour. The mixture was filtered and well washed with pure water, then again placed in a screw vial (20 ml), and pure water (10 ml) was added thereto, then the mixture was stirred at room temperature at 60 rpm using a horizontal mixing rotor under light shielding for 2 hours. The silica gel was again separated by filtration, and well washed with pure water. The solvent was distilled off under reduced pressure, to obtain an adsorbent of Example 4 as a pale yellow particle (yield=0.523 g).

### COMPARATIVE EXAMPLE 2

Tests of adsorptivity were conducted in the same manner as in Example 1, using a commercially available silver-supported zeolite (an amount of silver supported of 2.5 wt %) as an adsorbent.

Next, tests of adsorptivity of example 1 will be explained. Potassium iodide (654 mg) was put in a measuring flask (500 ml), and pure water was added thereto to fill up to a marked line to obtain an aqueous solution containing iodide ion (I−) at a concentration of 1000 ppm (ppm: mg/L).

Subsequently, the aqueous solution (250 ml) containing iodide ion (I⁻) at a concentration of 1000 ppm obtained as described above was put in a measuring flask (500 ml), and pure water was added thereto to fill up to a marked line to obtain an aqueous solution containing iodide ion (I⁻) at a concentration of 500 ppm.

Moreover, the aqueous solution (250 ml) containing iodide ion (I⁻) at a concentration of 1000 ppm obtained as described above and sodium chloride (411 mg) were put in a measuring flask (500 ml), and pure water was added thereto to fill up to a marked line to obtain an aqueous solution containing iodide ion (I⁻) and chloride ion (Cl⁻) each at a concentration of 500 ppm.

Subsequently, the adsorbent (20 mg) and test solution (20 ml) containing iodide ion at a concentration of 500 ppm obtained as described above were placed in a screw vial (30 ml), and the mixture was stirred at room temperature at 60 rpm using a horizontal mixing rotor under light shielding for 1 hour. Thereafter, the solution was filtered using a cellulose membrane filter with a pore size of 0.2 μm (Minisart RC-15), and the iodide ion concentration in the resulting aqueous solution was determined.

The iodide ion concentration was calculated using ion chromatography. Using Alliance HPLC system manufactured by Nihon Waters K.K. as an ion chromatography apparatus, the iodide ion concentration was determined in the following conditions.
Column Shodex IC SI-90 4E
Eluent 1.8 mM Na₂CO₃+1.7 mM NaHCO₃ aq.
Flow rate 1.2 mL/min
Detector Shodex CD Suppressor module
Column temperature 30° C.

As the index of the adsorption ability of iodide ion, the adsorption amount of iodide ion per unit weight (hereinafter described as mg-I/g) was used.

In the same manner, using the solution containing iodide ion and chloride ion each at a concentration of 500 ppm as a test solution, the adsorption ability of iodide ion was calculated in the coexistence of competing ion.

The Ag/S ratio was quantitatively analyzed by XPS in the aforementioned conditions.

The Ag content rate [wt %]was determined by ICP (Induced Coupled Plasma) emission spectrometric analysis. Specifically, an adsorbent was degraded by appropriate acid, and the eluted metal ion concentration was calculated by ICP emission spectrometric analysis using SPS-4000 manufactured by SII NanoTechnology Inc.

The NO₃⁻ detected intensity was determined by ion chromatography. Specifically, the iodide ion concentration was determined in the following conditions, using Alliance HPLC system manufactured by Nihon Waters K.K..
Column Shodex IC SI-90 4E
Eluent 1.8 mM Na₂CO₃+1.7 mM NaHCO₃ aq.
Flow rate 1.2 mL/min
Detector Shodex CD Suppressor module
Column temperature 30° C.

Results of the aforementioned tests performed with respect to the adsorbents obtained in Examples 1 to 3 and Comparative examples 1 and 2 as described above, are shown in Table 1.

TABLE 1

| | | Adsorption | | | |
|---|---|---|---|---|---|
| | | Amount | | | |
| | Adsorption | (I⁻ | Ag | | |
| | Amount | coexistent | Content | | |
| | (only I⁻) | with Cl⁻) | Rate | Ag/S | |
| | mgI⁻/g | mgI−/g | wt % | Ratio | NO₃⁻ |
| Example 1 | 60.2 | 78.7 | 20.1 | 2.9 | 261179 |
| Example 2 | 61.4 | 76.0 | 20.4 | 2.7 | 225185 |
| Example 3 | 54.7 | 68.1 | — | — | 252215 |
| Comparative | 62.8 | 65.9 | 12.7 | 2.0 | 105372 |
| Example 1 | | | | | |
| Comparative | 27.0 | 30.0 | 2.5 | — | ND |
| Example 2 | | | | | |

NO₃⁻: NO₃⁻ Detected Intensity (mV * sec: detected intensity area)

### EXAMPLE 4

A recovery flask (50 ml) equipped with a magnetic stir bar and a Dimroth condenser was charged with 3-mercaptopropyl trimethoxy silane (8.8 g, 44.8 mmol) and toluene (20 ml), and the mixture was stirred to form a homogeneous solution. Thereto was added silica gel (acid silica gel, silica gel 60 manufactured by KANTO CHEMICAL CO., INC., 5.06 g), and the mixture was heated and stirred at 110° C. for 10 hours. The temperature of the flask was returned to room temperature, and the silica gel was separated by filtration. The silica gel was washed with toluene (30 ml), then the solvent was distilled off under reduced pressure, to obtain a silica gel into which the organic group was introduced as a colorless particle (yield=6.3 g).

Subsequently, the silica gel carrier (1.008 g) into which the organic group was introduced as described above was placed in a recovery flask (50 ml) equipped with a magnetic stir bar and a Dimroth condenser. Thereto was added mathanol (20 ml), and the mixture was heated and stirred at 60° C. for 6 hours. The temperature of the flask was returned to room temperature, and the silica gel was separated by filtration. The silica gel was washed with in order of methanol (20 ml) and pure water (30 ml), then the solvent was distilled off under reduced pressure, to obtain a denatured form of a silica gel carrier having an organic group as a colorless particle (yield=1.043 g).

Subsequently, the denatured form of the silica gel carrier having an organic group (0.500 g) was placed in a screw vial (20 ml), and a 3% by weight aqueous silver nitrate solution (10 ml) was added thereto, then the mixture was stirred at room temperature at 60 rpm using a horizontal mixing rotor under light shielding for 1 hour. The mixture was filtered and well washed with pure water, then again placed in a screw vial (20 ml), and pure water (10 ml) was added thereto, then the mixture was stirred at room temperature at 60 rpm using a horizontal mixing rotor under light shielding for 2 hours. The silica gel was again separated by filtration, and well washed with pure water. The solvent was distilled off under reduced pressure, to obtain an adsorbent of Example 4 as a pale yellow particle (yield=0.623 g).

### EXAMPLE 5

The same procedures were carried out as in Example 4, except for not heating the mixed solution under reflux in methanol, to obtain the adsorbent of Example 5. The silica gel carrier having an organic group (0.500 g) was placed in a screw vial (20 ml) as described in Example 4, and a 3% by weight aqueous silver nitrate solution (10 ml) was added thereto, then the mixture was stirred at room temperature at 60 rpm using a horizontal mixing rotor under light shielding for 1 hour. The mixture was filtered and well washed with pure water, then again placed in a screw vial (20 ml), and pure water (10 ml) was added thereto, then the mixture was stirred at room temperature at 60 rpm using a horizontal mixing rotor under light shielding for 2 hours. The silica gel was again separated by filtration, and well washed with pure water. The solvent was distilled off under reduced pressure, to obtain an adsorbent of Example 5 as a pale yellow particle (yield=0.635 g).

Results of the aforementioned tests performed with respect to the adsorbents obtained in Examples 4 to 5 and Comparative example 2 as described above, are shown in Table 2.

In the tests shown in Table 2, test solution at a concentration of 500 mg/L of KI as a solution of only I−, and test solution at concentrations of 500 mg/L of KI and 500 mg/L of NaCl as a solution of I⁻ coexistent with Cl⁻ are used. In the tests shown in Table 2, test solution of 10 ml, adsorbent of 20 mg and flask whose volume is 20 mL are used.

TABLE 2

| | | Adsorption | | |
|---|---|---|---|---|
| | Adsorption | Amount | Ag | |
| | Amount | (I⁻ coexistent | Content | |
| | (only I⁻) | with Cl⁻) | Rate | Ag/S |
| | mgI⁻/g | mgI−/g | wt % | Ratio |
| Example 4 | 69.3 | 77.8 | 22.0 | 2.9 |
| Example 5 | 58.9 | 67.5 | 20.4 | 2.6 |
| Comparative | 57.3 | 52.6 | 12.7 | — |
| Example 1 | | | | |

As is apparent from Table 1, it can be understood that, regarding the adsorbents obtained in the examples, the adsorption ability of iodide ion is high in the coexistence of chloride ion that is a competing ion, as compared to the comparative examples. In addition, it was confirmed that the iodine adsorbents of the examples released more nitrate ions as compared to those of the comparative examples.

As is apparent from Table 2, it can be understood that, regarding the adsorbents obtained in the examples, the adsorption ability of iodide ion is high in the coexistence of chloride ion that is a competing ion, as compared to the comparative examples. In addition, as is apparent from Table 1 and 2, it can be understood that adsorbent having acidic support and having neutral support have similar character of adsorption ability of iodide ion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An iodine adsorbent comprising:
a carrier;
an organic group binding to the carrier; and
silver,
wherein the organic group has a functional group represented by S⁻ or SR at the terminal,
the silver binds to the sulfur in S⁻ or SR,
the R is a hydrogen atom or a substituent containing hydrocarbon, and
the atomic ratio of the silver to the sulfur is 2.6 or more and 2.9 or less.

2. The iodine adsorbent according to claim 1, wherein the functional group represented by SR is any functional group of thiol, sulfide and thioester polyol.

3. The iodine adsorbent according to claim 1, wherein the carrier is selected from neutral silica gel, acid silica gel, acrylic resins or metal oxides.

4. The iodine adsorbent according to claim 1, wherein the organic group binds to the carrier by coupling reaction.

5. The iodine adsorbent according to claim 1, wherein the adsorbent in which the organic group is bound to the carrier is heated in an alcohol, and
subsequently, the silver is supported.

6. A tank for water treatment that accommodates an iodine adsorbent comprising:
a carrier;
an organic group binding to the carrier; and
silver,
wherein the organic group has a functional group represented by S⁻ or SR at the terminal,
the silver binds to the sulfur in S⁻ or SR,
the R is a hydrogen atom or a substituent containing hydrocarbon, and
the atomic ratio of the silver to the sulfur is 2.6 or more and 2.9 or less.

7. The tank according to claim 6, wherein the functional group represented by SR is any functional group of thiol, sulfide and thioester polyol.

8. The tank according to claim 6, wherein the carrier is at least any of neutral silica gel, acid silica gel, acrylic resins and metal oxides.

9. The tank according to claim 6, wherein the organic group binds to a carrier by coupling reaction.

10. The tank according to claim 6, wherein the member in which the organic group is bound to the carrier is heated in an alcohol, and
subsequently, the silver is supported.

11. An iodide compound treatment system comprising:
an adsorbent unit having an iodine adsorbent;
a supplying unit supplying target medium including iodide compound for the iodide adsorbent of the adsorbent unit;
a discharging unit discharging the target medium from the adsorbent unit;
a measuring unit measuring concentration of iodide compound in the target medium provided in the supplying unit side and/or the discharging unit side; and
a controller controlling flow of the target medium from the supplying unit to the adsorbent unit when a value calculated from a measured value in the measuring unit reaches set value,
wherein the iodine adsorbent comprising:
a carrier;
an organic group binding to the carrier; and
silver,
wherein the organic group has a functional group represented by S⁻ or SR at the terminal,
the silver binds to the sulfur in S⁻ or SR,
the R is a hydrogen atom or a substituent containing hydrocarbon, and
the atomic ratio of the silver to the sulfur is 2.6 or more and 2.9 or less into contact with iodine-containing water, to recover iodine contained in the iodine-containing water.

12. The system according to claim 11, wherein the functional group of the adsorbent represented by SR is any functional group of thiol, sulfide and thioester polyol.

13. The system according to claim 11, wherein the carrier of the adsorbent is selected from neutral silica gel, acid silica gel, acrylic resins or metal oxides.

14. The system according to claim 11, wherein the organic group of the adsorbent binds to a carrier by coupling reaction.

15. The system according to claim 11, wherein the adsorbent in which the organic group is bound to the carrier is heated in an alcohol, and
subsequently, the silver is supported.

16. The system according to claim 11, wherein the measuring unit measuring concentration of iodide in the target medium sequentially.
